(19) United States
(12) Patent Application Publication
(10) Pub. No.: US 2025/0379374 A1
(43) Pub. Date: Dec. 11, 2025

(54) HIGH-VOLTAGE SPRING CLIP

(71) Applicant: Schaeffler Technologies AG & Co. KG, Herzogenaurach (DE)

(72) Inventors: Rebeca DORANTES, Huejotzingo (MX); Alejandro ISUNZA, Puebla (MX); Aurora Montserrat GOMEZ, Xalapa (MX); Antonio CORTES, Puebla (MX); Emanuel ROCHA, San Martin Texmelucan (MX)

(21) Appl. No.: 18/737,521

(22) Filed: Jun. 7, 2024

(51) Int. Cl. H01R 4/48

(52) U.S. Cl. CPC H01R 4/48

(57) ABSTRACT

A spring clip for securing busbars of an electrical connector. The spring clip may include gripping members which exert pressure on the busbars, preventing the busbars from uncoupling. The spring clip provides a threadless means for joining the busbars, which is desirable for ease-of-assembly when coupling and uncoupling the electrical connector. The spring clip may include raised members for separating apart the gripping members using an external tool. The gripping members may include corrugated portions which engage with the busbars. The gripping members may also include rib members which may stiffen the gripping members.

### TECHNICAL FIELD

The present disclosure generally relates to electrical connections between conductive members, and, more particularly, to electrical connections secured by a spring, clip, or other resilient member.

### BACKGROUND

High-voltage (HV) electrical connections are used in several three-phase electric machines. The high-voltage electrical connections in the three-phase electric machines typically use a threaded connection. The threaded connection ensures the connection is maintained when subject to vibrations. The threaded connection may include a clinch nut, washer, and screw mechanism. The interface may include a relatively long time to assemble the screw and nut to secure the interface and may require the screw and nut for every interface. Therefore, it would be advantageous to provide a device, system, and method that cures the shortcomings described above.

### SUMMARY

A spring clip is described, in accordance with one or more embodiments of the present disclosure. The spring clip may include: a first gripping member; a second gripping member, wherein the first gripping member and the second gripping member include: a corrugated portion defining a plurality of grooves; and one or more rib portions, wherein the one or more rib portions are orthogonal to the plurality of grooves; a trapezoidal member, wherein the first gripping member and the second gripping member extend from the trapezoidal member, wherein the corrugated portion and the one or more rib portions of the first gripping member join the first gripping member to the trapezoidal member, wherein the corrugated portion and the one or more rib portions of the second gripping member join the second gripping member to the trapezoidal member; a first raised member, wherein the first raised member extends from the first gripping member, wherein the one or more rib portions of the first gripping member couple between the trapezoidal member and the first raised member; and a second raised member, wherein the second raised member extends from the second gripping member, wherein the one or more rib portions of the second gripping member couple between the trapezoidal member and the second raised member.

In some aspects, the trapezoidal member is configured to force the first gripping member and the second gripping member to a neutral position.

In some aspects, the spring clip is made of steel, aluminum, or magnesium.

In some aspects, at least the first gripping member, the second gripping member, and the trapezoidal member are formed from a single piece of resilient material.

In some aspects, the first raised member is welded to the first gripping member, wherein the second raised member is welded to the second gripping member.

In some aspects, the first gripping member, the second gripping member, the trapezoidal member, the first raised member, and the second raised member are formed from the single piece of resilient material.

In some aspects, the first gripping member is offset from the second gripping member, wherein the spring clip defines a channel between the first gripping member and the second gripping member.

In some aspects, the first gripping member includes a first pair of the one or more rib portions, wherein the second gripping member includes a second pair of the one or more rib portions.

In some aspects, the first pair of the one or more rib portions are disposed above and aligned with the second pair of the one or more rib portions.

In some aspects, the first pair of the one or more rib portions abut the first raised member, wherein the second pair of the one or more rib portions abut the second raised member.

In some aspects, the first raised member and the second raised member define a first hole and a second hole, respectively, wherein the first hole and the second hole are parallel to the one or more rib portions.

In some aspects, the first hole and the second hole are configured to receive a tool for separating apart the first gripping member and the second gripping member.

In some aspects, the first gripping member and the second gripping member include a straight portion, wherein the corrugated portion is disposed between the straight portion and the trapezoidal member.

In some aspects, the first raised member extends from the straight portion of the first gripping member and a section of the corrugated portion of the first gripping member, wherein the second raised member extends from the straight portion of the second gripping member and a section of the corrugated portion of the second gripping member.

In some aspects, the plurality of grooves are rounded grooves.

In some aspects, the one or more rib portions extend through the plurality of grooves.

In some aspects, the spring clip is symmetric about a longitudinal axis.

An electrical connector is described, in accordance with one or more embodiments of the present disclosure. The electrical connector may include: a spring clip including: a first gripping member; a second gripping member, wherein the first gripping member and the second gripping member include: a corrugated portion defining a plurality of grooves; and one or more rib portions, wherein the one or more rib portions are orthogonal to the plurality of grooves; a trapezoidal member, wherein the first gripping member and the second gripping member extend from the trapezoidal member, wherein the corrugated portion and the one or more rib portions of the first gripping member join the first gripping member to the trapezoidal member, wherein the corrugated portion and the one or more rib portions of the second gripping member join the second gripping member to the trapezoidal member; a first raised member, wherein the first raised member extends from the first gripping member, wherein the one or more rib portions of the first gripping member couple between the trapezoidal member and the first raised member; and a second raised member, wherein the second raised member extends from the second gripping member, wherein the one or more rib portions of the second gripping member couple between the trapezoidal member and the second raised member; a first busbar; and a second busbar, wherein the first busbar and the second busbar are disposed between the first gripping member and the second gripping member, wherein the first busbar abuts the first gripping member, wherein the second busbar abuts the second gripping member, wherein the first gripping member and the second gripping member join the first busbar and the second busbar.

In some aspects, the spring clip joins the first busbar and the second busbar without perforating through the first busbar and the second busbar.

A method is described, in accordance with one or more embodiments of the present disclosure. The method may include: separating apart a first gripping member and a second gripping member of a spring clip, the spring clip including: the first gripping member; the second gripping member, wherein the first gripping member and the second gripping member include: a corrugated portion defining a plurality of grooves; and one or more rib portions, wherein the one or more rib portions are orthogonal to the plurality of grooves; a trapezoidal member, wherein the first gripping member and the second gripping member extend from the trapezoidal member, wherein the corrugated portion and the one or more rib portions of the first gripping member join the first gripping member to the trapezoidal member, wherein the corrugated portion and the one or more rib portions of the second gripping member join the second gripping member to the trapezoidal member; a first raised member, wherein the first raised member extends from the first gripping member, wherein the one or more rib portions of the first gripping member couple between the trapezoidal member and the first raised member; and a second raised member, wherein the second raised member extends from the second gripping member, wherein the one or more rib portions of the second gripping member couple between the trapezoidal member and the second raised member; receiving a first busbar and a second busbar between the first gripping member and the second gripping member while the first gripping member and the second gripping member are separated apart; and joining the first busbar and the second busbar via the first gripping member and the second gripping member.

### BRIEF DESCRIPTION OF THE DRAWINGS

The numerous advantages of the disclosure may be better understood by those skilled in the art by reference to the accompanying figures in which:

FIG. 1A depicts an isometric view of a spring clip in a neutral position, in accordance with one or more embodiments of the present disclosure.

FIG. 1B depicts a side view of the spring clip in the neutral position, in accordance with one or more embodiments of the present disclosure.

FIG. 1C depicts a top view of the spring clip in the neutral position, in accordance with one or more embodiments of the present disclosure.

FIG. 1D depicts a front view of the spring clip in the neutral position, in accordance with one or more embodiments of the present disclosure.

FIG. 1E depicts a back view of the spring clip in the neutral position, in accordance with one or more embodiments of the present disclosure.

FIG. 2A depicts an isometric view of the spring clip in the neutral position, in accordance with one or more embodiments of the present disclosure.

FIG. 2B depicts a back view of the spring clip in the neutral position, in accordance with one or more embodiments of the present disclosure.

FIG. 3A depicts an isometric view of an electrical connector with the spring clip, in accordance with one or more embodiments of the present disclosure.

FIG. 3B depicts a side view of the electrical connector with the spring clip, in accordance with one or more embodiments of the present disclosure.

FIG. 4 depicts a flow diagram of a method, in accordance with one or more embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure are directed to a spring clip for securing busbars of an electrical connector. The spring clip may include gripping members which exert pressure on the busbars, preventing the busbars from uncoupling. The spring clip provides a threadless means for joining the busbars, which is desirable for ease-of-assembly when coupling and uncoupling the electrical connector. The spring clip may include raised members for separating apart the gripping members using an external tool. The gripping members may include corrugated portions which engage with the busbars. The gripping members may also include rib members which may stiffen the gripping members.

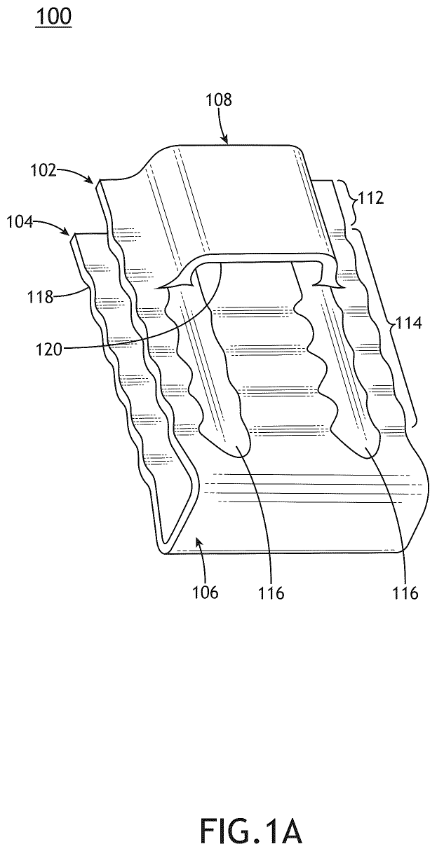

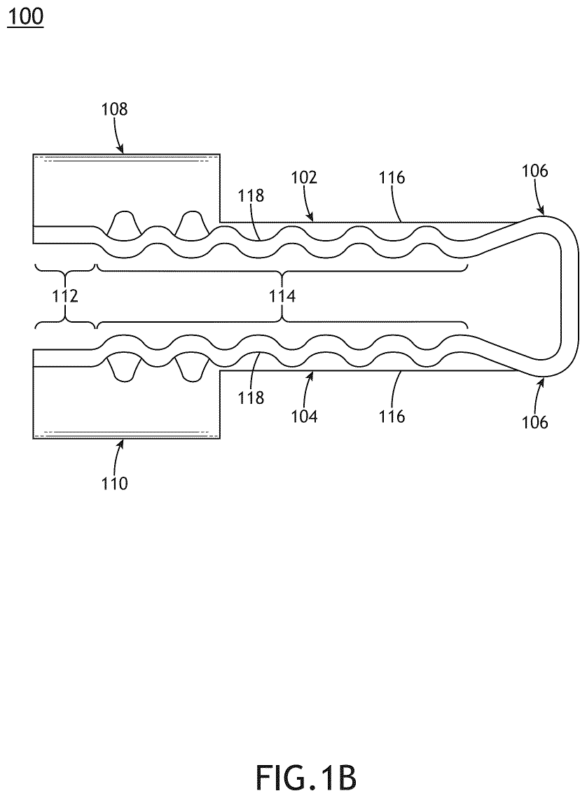

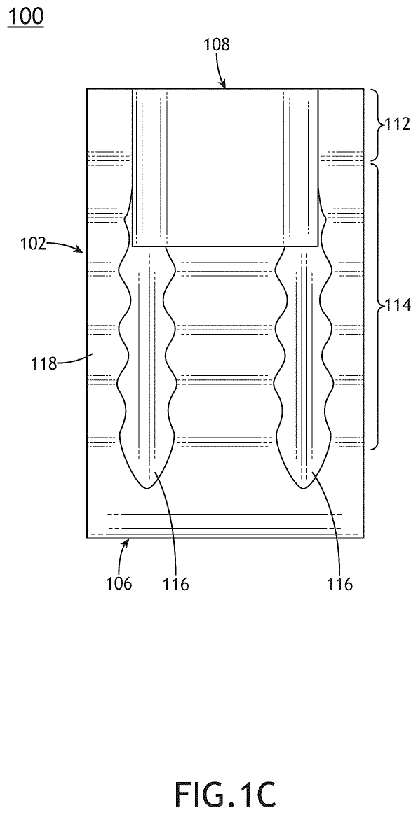

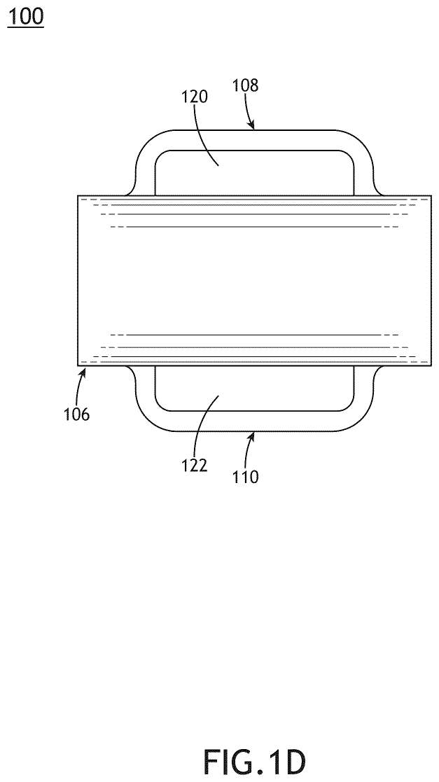

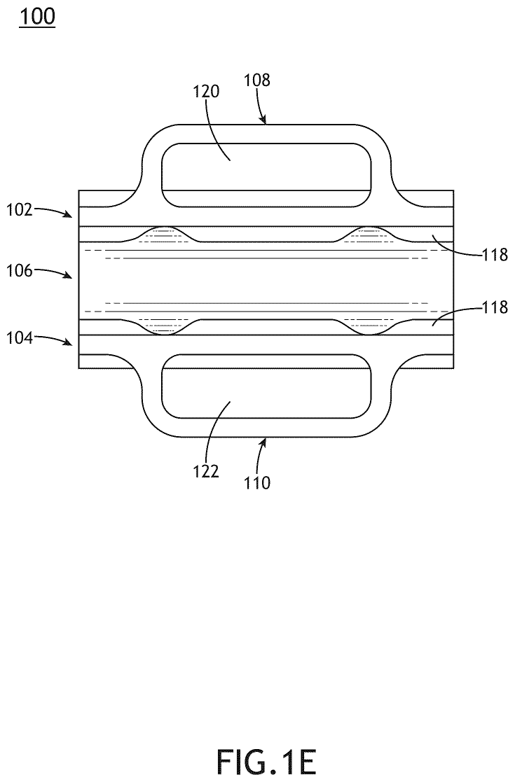

FIGS. 1A-1E depict a spring clip 100, in accordance with one or more embodiments of the present disclosure. The spring clip 100 may be a binder clip, a foldback clip, or the like. The spring clip 100 may include a gripping member 102, a gripping member 104, a trapezoidal member 106, a raised member 108, and/or a raised member 110.

The gripping member 102 and the gripping member 104 may be referred to as a first gripping member and a second gripping member, respectively. The gripping member 102 and/or the gripping member 104 may be a horizontal or longitudinal part of the spring clip 100. For example, the gripping member 102 and/or the gripping member 104 may extend along the longitudinal axis of the spring clip 100.

The gripping member 102 and/or the gripping member 104 may have a selected length. For example, the gripping member 102 and the gripping member 104 may each have the same length. Although the gripping member 102 and the gripping member 104 are described as having the same length, this is not intended as a limitation of the present disclosure. It is further contemplated that the gripping member 102 and the gripping member 104 may have differing lengths.

The trapezoidal member 106 may include a trapezoidal shape. For example, the trapezoidal member 106 may include the trapezoidal shape when viewing from a side of the spring clip 100.

The gripping member 102 and/or the gripping member 104 may extend from the trapezoidal member 106. The trapezoidal member 106 may join the gripping member 102 and/or the gripping member 104.

The gripping member 102 may be offset from the gripping member 104. The gripping member 102 and the gripping member 104 may be in offset planes. For example, the gripping member 102 and the gripping member 104 may each be in a horizontal plane, where the horizontal planes are offset.

The spring clip 100 may define a channel between the gripping member 102 and the gripping member 104. For example, the width of the channel between the gripping member 102 and/or the gripping member 104 may be based on a height of the trapezoidal member 106.

The gripping member 102 and/or the gripping member 104 may be forced together by the trapezoidal member 106. The trapezoidal member 106 may force the gripping member 102 and/or the gripping member 104 to a neutral position. The gripping member 102 and the gripping member 104 may be in the horizontal planes in the neutral position. For example, the gripping member 102 and the gripping member 104 may be in offset horizontal planes in the neutral position.

The spring clip 100 may be a resilient member with an inherent resistance to deformation. The spring clip 100 may return to an original shape after being deformed. The spring clip 100 may have a selected elastic modulus sufficient to allow the spring clip to deform and then recover to the original shape. The spring clip 100 may be elastically deformed by an external force separating apart the gripping member 102 and the gripping member 104 from the neutral position (e.g., overcoming the force from the trapezoidal member 106). An internal stress within the spring clip 100 may return the gripping member 102 and the gripping member 104 may return towards each other to the neutral position once the external force is removed. For example, the internal stress may be within the trapezoidal member 106 by which the trapezoidal member 106 may force the gripping member 102 and the gripping member 104 to the neutral position.

The return of the gripping member 102 and the gripping member 104 to the neutral position may affect a gripping action on one or more objects disposed between the gripping member 102 and the gripping member 104. For example, the gripping action may be on one or more objects disposed in the channel between the gripping member 102 and the gripping member 104.

The gripping action of the spring clip 100 may be solely by the inherent resistance to deformation of the spring clip 100. The spring clip 100 may not include a clamp. Thus, the spring clip 100 may provide an interface with fewer components than a clinch nut, washer, and screw mechanism.

The spring clip 100 may be made of a select material. The select material may be resilient and may not galvanically corrode when in contact with copper. For example, the spring clip 100 may be made of steel (e.g., spring steel), aluminum, magnesium, high-strength alloys, composites, or another resilient material which does not galvanically corrode when in contact with copper. The inherent resistance to deformation of the spring clip 100 may be based on the elastic modulus of the material.

The gripping member 102, the gripping member 104, the trapezoidal member 106, raised member 108, and/or the raised member 110 may be formed from a single piece of resilient material. For example, the gripping member 102, the gripping member 104, the trapezoidal member 106, raised member 108, and/or the raised member 110 may be cut, shaped, pressed, or otherwise formed form the single piece of resilient material. The single piece of resilient material may a uniformly thick and planar material. For example, the single piece of resilient material may be sheet metal or the like. The spring clip 100 may be formed from the sheet metal. The spring clip 100 may be formed from a continuous length of sheet metal. The sheet metal may be bent to define the gripping member 102, gripping member 104, the trapezoidal member 106, raised member 108, and/or the raised member 110.

The gripping member 102 and/or the gripping member 104 may or may not be straight along the entire length. The gripping member 102 and the gripping member 104 may include straight portions 112, corrugated portions 114, and/or rib portions 116.

The straight portions 112 may be disposed at one end of the spring clip 100. The straight portions 112 may be aligned with the longitudinal axis of the spring clip 100. The straight portion 112 of the gripping member 102 may be aligned with and disposed above the straight portion 112 of the gripping member 104.

The straight portions 112 may be beneficial when assembling the spring clip 100. For example, the straight portions 112 may allow inserting the one or more objects between the gripping member 102 and/or the gripping member 104 when the gripping member 102 and/or the gripping member 104 are separated apart from each other.

The corrugated portions 114 and/or the rib portions 116 may extend from the trapezoidal member 106. The corrugated portion 114 and/or the rib portions 116 may join the gripping member 102 and the gripping member 104 to the trapezoidal member 106. For example, the corrugated portion 114 and/or the rib portions 116 of the gripping member 102 may join the gripping member 102 to the trapezoidal member 106. By way of another example, the corrugated portion 114 and/or the rib portions 116 of the gripping member 104 may join the gripping member 104 to the trapezoidal member 106.

The corrugated portion 114 of the gripping member 102 may be aligned with and disposed above the corrugated portion 114 of the gripping member 104. The corrugated portions 114 may be disposed between the straight portions 112 and the trapezoidal member 106.

The corrugated portions 114 may define grooves 118. The grooves 118 may be orthogonal to the longitudinal axis of the spring clip 100 and run along the width of the spring clip 100. The grooves 118 may also be referred to as waves, flutes, ridges, or valleys. The grooves 118 may include rounded grooves (as depicted) or straight grooves (not depicted). The corrugated portions 114 may include any number of the grooves 118. The corrugated portions 114 may include at least two of the grooves 118. For example, the corrugated portions 114 of the gripping member 102 and/or the gripping member 104 are each depicted with eleven of the grooves 118, although this is not intended to be limiting. The grooves 118 may alternate between being disposed above and below the straight portions 112. The grooves 118 may follow a wave pattern. For example, the grooves 118 may include a sinusoidal pattern (as depicted), a square wave pattern, a triangle wave pattern, a sawtooth wave pattern, or the like. The wave pattern may repeat along the longitudinal axis of the spring clip 100. The grooves 118 may include an amplitude (i.e., height) and a wavelength. The amplitude and wavelength may control a stiffness of the corrugated portions 114.

The corrugated portions 114 may be configured to engage with an object disposed between the gripping member 102 and the gripping member 104. For example, the corrugated portions 114 may act as teeth for grabbing the object. For instance, the grooves 118 of the corrugated portions 114 may engage with the object by acting as individual of the teeth.

The gripping member 102 and/or the gripping member 104 may include one or more of the rib portions 116. The rib portions 116 may be aligned with the longitudinal axis of the spring clip 100. The rib portions 116 of the gripping member 102 may be aligned with and disposed above the rib portions 116 of the gripping member 104. The rib portions 116 may be orthogonal to the grooves 118.

The rib portions 116 may extend through the grooves 118. Thus, the rib portions 116 may form a continuous length which is unbroken by the grooves 118. The grooves 118 may form a discontinuous length which is broken by the rib portions 116. The grooves 118 may be disposed on either side of the rib portions 116.

The rib portions 116 of the gripping member 102 may couple between the trapezoidal member 106 and the raised member 108. Similarly, the rib portions 116 of the gripping member 104 may couple between the trapezoidal member 106 and the raised member 110. The rib portions 116 may transfer forces between the trapezoidal member 106, the raised member 108, and the raised member 110. The rib portions 116 may be reinforcing members for the gripping member 102 and/or the gripping member 104. The rib portions 116 may control a stiffness of the gripping member 102 and/or the gripping member 104. For example, the addition of the rib portions 116 may increase a stiffness of the corrugated portions 114.

A top-most surface of the trapezoidal member 106 may be disposed above a top surface of the gripping member 102. Similarly, a bottom-most surface of the trapezoidal member 106 may be disposed below a bottom surface of the gripping member 102. For example, the top-most surface of the trapezoidal member 106 may be disposed above the grooves 118 of the gripping member 102 and below the grooves 118 of the gripping member 102.

The raised member 108 and the raised member 110 may be referred to as a first raised member and a second raised member, respectively. The raised member 108 and the raised member 110 may include a shape, such as, but not limited to, a stadium shape. For example, the raised member 108 and the raised member 110 may include a shape when viewed from a back and/or a front of the spring clip 100.

The raised member 108 and the raised member 110 may extend from the gripping member 102 and the gripping member 104, respectively. The raised member 108 and the raised member 110 may be raised by extending above the gripping member 102 and below the gripping member 104, respectively. The raised member 108 and the raised member 110 may extend from the straight portion 112 and/or a section of the corrugated portion 114. For example, the raised member 108 extend from the straight portion 112 of the gripping member 102 and/or a section of the corrugated portion 114 of the gripping member 102. By way of another example, the raised member 110 may extend from the straight portion 112 of the gripping member 104 and/or a section of the corrugated portion 114 of the gripping member 104. A length of the section of the corrugated portion 114 may be less than the entire length of the corrugated portion 114.

The raised member 108 and the raised member 110 may be disposed at the first end of the spring clip 100. The trapezoidal member 106 may be disposed at a second end of the spring clip 100. The raised member 108, the raised member 110, and/or the straight portions 112 may be disposed at an opposing end to the trapezoidal member 106.

The raised member 108 and the raised member 110 may be a top-most surface and a bottom-most surface, respectively, of the spring clip 100.

The raised member 108 and the raised member 110 may define a hole 120 and a hole 120, respectively. The hole 120 and the hole 120 may be referred to as a first hole and a second hole, respectively. The hole 120 and the hole 120 may be aligned with the longitudinal axis of the spring clip 100. The hole 120 and the hole 122 may be parallel to the rib portions 116 and/or orthogonal to the grooves 118. The hole 120 and the hole 120 may be through the length of the raised member 108 and the raised member 110, respectively.

The hole 120 and the hole 120 may be configured to receive a tool for separating apart the gripping member 102 and the gripping member 104. For example, the hole 120 and the hole 120 may be configured to receive a snap ring plier. The snap ring plier may separate apart the gripping member 102 and the gripping member 104. The snap ring plier include an inverse mechanism where closing handles of the snap ring plier may separate apart the gripping member 102 and the gripping member 104 and where opening the handles of the snap ring plier may allow the gripping member 102 and the gripping member 104 to return to the neutral position due to the force of the trapezoidal member 106.

The gripping member 102 and/or the gripping member 104 may each include pairs of the rib portions 116. For example, the gripping member 102 and the gripping member 104 may include a first pair and a second pair, respectively, of the rib portions 116. The first pair of the rib portions 116 of the gripping member 102 may be disposed above and aligned with the second pair of the rib portions 116 of the gripping member 104.

The pairs of the rib portions 116 of the gripping member 102 and the gripping member 104 may abut the raised member 108 and the raised member 110, respectively. The pairs of the rib portions 116 of the gripping member 102 and the gripping member 104 may provide access to the hole 120 and the hole 122 defined by the raised member 108 and the raised member 110, respectively. For example, the pairs of the rib portions 116 of the gripping member 102 and the gripping member 104 may provide the snap ring pliers access to the hole 120 and the hole 122 defined by the raised member 108 and the raised member 110, respectively.

The gripping member 102, the gripping member 104, the trapezoidal member 106, the raised member 108, and/or the raised member 110 may include a select thickness. The thickness may be uniform throughout the gripping member 102, the gripping member 104, the trapezoidal member 106, the raised member 108, and/or the raised member 110.

The spring clip 100 may include a selected cross-section. For example, the spring clip 100 may include a rectangular cross section. Any of the gripping member 102, gripping member 104, and/or trapezoidal member 106 may include the selected cross-section.

The spring clip 100 may be symmetric about the longitudinal axis. The spring clip 100 may have 180-degree rotational symmetry about the longitudinal axis. The spring clip 100 may be rotated 180-degrees around the longitudinal axis of the spring clip 100 such that, upon rotation, a top of the spring clip 100 functions as a bottom, and vice versa. For example, the gripping member 102 may act as the gripping member 104, and vice versa. By way of another example, the raised member 108 may act as the raised member 110, and vice versa.

The raised member 108 and the raised member 110 may be joined to the gripping member 102 and the gripping member 104, respectively. For example, the raised member 108 and the raised member 110 may be joined to the gripping member 102 and the gripping member 104 by a weld.

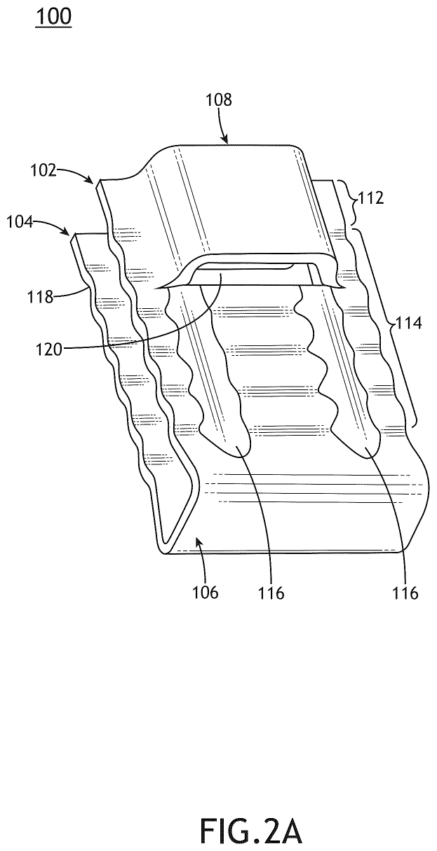

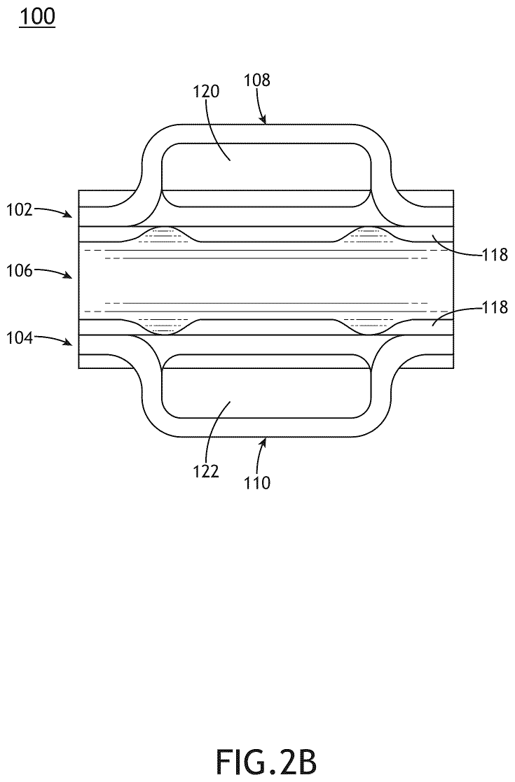

FIGS. 2A-2B depict the spring clip 100, in accordance with one or more embodiments of the present disclosure. Although the raised member 108 and the raised member 110 are described as being joined to the gripping member 102 and the gripping member 104 by a weld, this is not intended as a limitation of the present disclosure. The raised member 108 and the raised member 110 may be joined as a monolithic unit to the gripping member 102 and the gripping member 104. For example, the raised member 108 and the raised member 110 may be formed by pressing the gripping member 102 and the gripping member 104 outwards from the gripping member 102 and the gripping member 104, respectively. In this example, the area between the raised member 108 and the raised member 110 may be a void space which does not include portions of gripping member 102 and the gripping member 104. Thus, the spring clip 100 may be cut or shaped from a single sheet of resilient, uniformly thick, planar material.

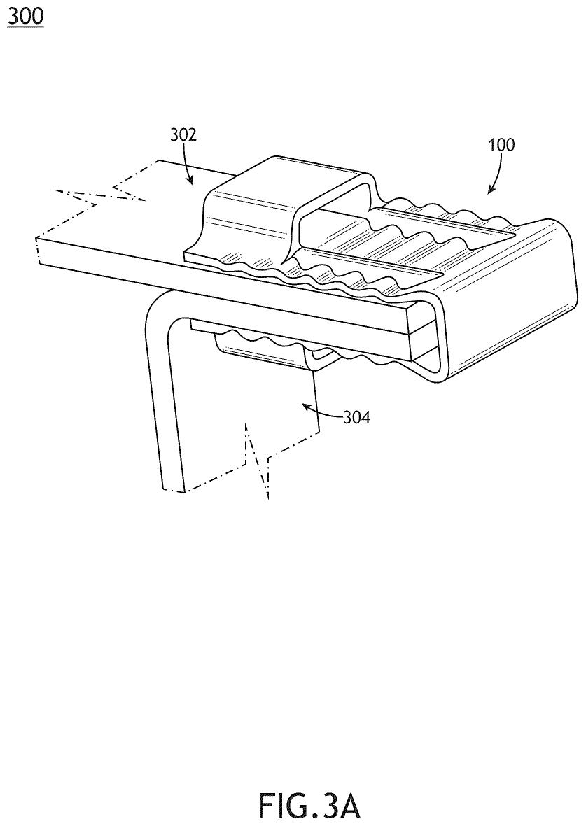

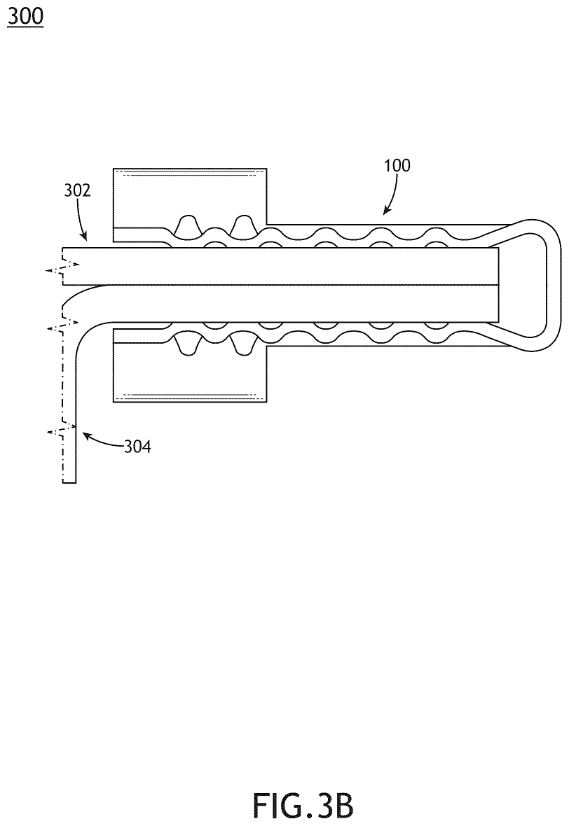

FIGS. 3A-3B depict an electrical connector 300, in accordance with one or more embodiments of the present disclosure. The electrical connector 300 may include the spring clip 100, a busbar 302, and/or a busbar 304.

The busbar 302 may also be referred to as a junction box busbar and/or a first busbar. The busbar 304 may also be referred to as a HV header busbar and/or a second busbar.

The busbar 302 and the busbar 304 may be rigid elements. The busbar 302 and the busbar 304 each include a flat metal plate. For example, the busbar 302 and the busbar 304 may each have a thickness which may be much smaller than the width and length. The busbar 302 and the busbar 304 may be made of an electrical conductor. The busbar 302 and the busbar 304 may be made from copper, aluminum, or an alloy thereof. For example, the busbar 302 and the busbar 304 may be made from copper.

The busbar 302 and the busbar 304 may engage to form an electrical connection. The electrical connector 300 may be adapted for repeated physical engagement or disengagement for establishing and breaking the electrical connection.

The busbar 302 and the busbar 304 may be disposed between the gripping member 102 and the gripping member 104. For example, the busbar 302 and the busbar 304 may be disposed in the channel between the gripping member 102 and the gripping member 104.

The busbar 302 and the busbar 304 may abut the spring clip 100. For example, the busbar 302 and the busbar 304 may abut the gripping member 102 and the gripping member 104, respectively. For instance, the busbar 302 and the busbar 304 may abut the corrugated portion 114 of the gripping member 102 and the corrugated portion 114 of the gripping member 104, respectively. The spring clip 100 may contact the busbar 302 and the busbar 304. For example, the gripping member 102 and the gripping member 104 may contact the busbar 302 and the busbar 304, respectively. For instance, the corrugated portions 114 of the gripping member 102 and the gripping member 104 may contact the busbar 302 and the busbar 304, respectively. The spring clip 100 may contact the busbar 302 and the busbar 304 with a contact area. The contact area may be at least as wide as the cross-section of the busbar 302 and the busbar 304. The contact area may be at least twice as wide as the cross-section of the busbar 302 and the busbar 304. For example, the contact area may be at least sixty-four square millimeters.

The spring clip 100 may be configured to join or secure the busbar 302 and the busbar 304. The spring clip 100 may exert pressure on the busbar 302 and the busbar 304. The force provided by the trapezoidal member 106 on the gripping member 102 and the gripping member 104 may cause the spring clip 100 to join the busbar 302 and the busbar 304. The spring clip 100 may secure together the busbar 302 and the busbar 304 by a friction-grip between the gripping member 102, the busbar 302, the busbar 304, and the gripping member 104. The gripping action may be affected by the inherent resistance to deformation of the spring clip 100. The gripping action may be an external or a contracting action. The spring clip 100 may force together the gripping member 102 and the gripping member 104 securing together the busbar 302 and the busbar 304. The gripping action may compress together the busbar 302 and the busbar 304. The gripping member 102 and the gripping member 104 may exert pressure thereby preventing separation of the busbar 302 and the busbar 304. The corrugated portions 114 may engage with the busbar 302 and the busbar 304. The corrugated portions 114 may bite into the busbar 302 and the busbar 304 to improve the contact. The corrugated portions 114 of the gripping member 102 and the gripping member 104 may engage with the busbar 302 and the busbar 304, respectively.

The spring clip 100 may join the busbar 302 and the busbar 304 without perforating through the busbar 302 and the busbar 304. The busbar 302 and the busbar 304 may not include a bolt hole. The electrical connector 300 may be formed without the use of bolts, clips, rivets, or the like.

The spring clip 100 may be a high-voltage (HV) spring clip. The electrical connector 300 may be a high-voltage electrical connector. For example, the electrical connector 300 may be rated to carry over 1,000 VAC. Although the electrical connector 300 is described as a high voltage electrical connector, this is not intended as a limitation of the present disclosure. The electrical connector 300 may also be a low voltage electrical connector. The benefits provided by the spring clip 100 may apply to both low-voltage and high-voltage connectors.

The electrical connector 300 may be used for an electrical machine. The electrical machine may include any electrical machine. For example, the electrical machine may include an electric motor. The busbar 304 may conduct current from the busbar 302 to a stator of the electric motor. The electric motor may be a three-phase electric motor. The electric motor may be used as a traction drive in a vehicle drive system. Thus, the electrical connector 300 may be a high-voltage connector for a three-phase electrical machine. The three-phase electrical machine may include at least three of the electrical connectors 300.

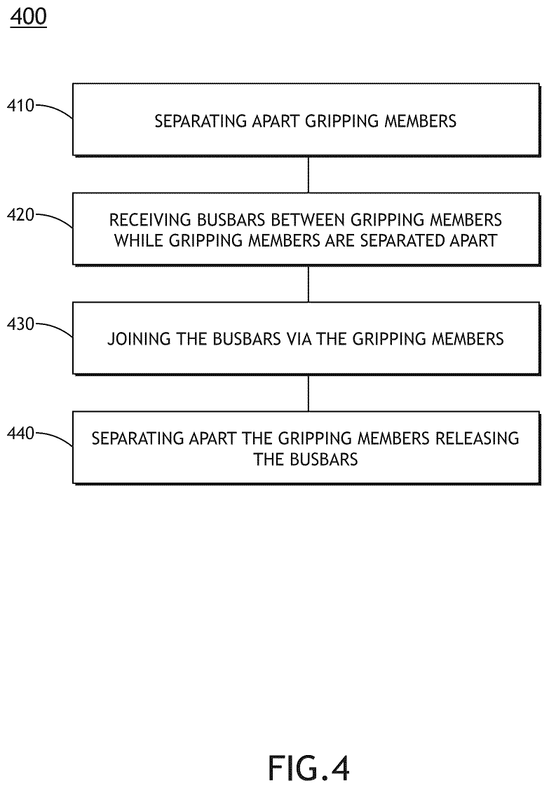

FIG. 4 illustrates a flow diagram of a method 400, in accordance with one or more embodiments of the present disclosure. The method 400 provides a means for joining and releasing the electrical connector 300. The embodiments and the enabling technology described previously herein in the context of the spring clip 100 and the electrical connector 300 should be interpreted to extend to the method. It is further recognized, however, that the method is not limited to the spring clip 100 and the electrical connector 300.

In a step 410, gripping members may be separated apart. For example, the gripping member 102 and the gripping member 104 may be separated apart. The gripping member 102 and the gripping member 104 may be separated apart from the neutral position. The spring clip 100 may prevent insertion of both the busbar 302 and the busbar 304 when in the neutral position and may allow insertion of both the busbar 302 and the busbar 304 when separated apart from the neutral position.

The gripping member 102 and the gripping member 104 may be separated apart via the raised member 108 and the raised member 110. For example, a tool may be received in the hole 120 and the hole 122 and then the tool may separate apart the gripping member 102 and the gripping member 104.

In a step 420, busbars may be received between the gripping members while the gripping members are separated apart. For example, the busbar 302 and the busbar 304 may be received between the gripping member 102 and the gripping member 104 while the gripping member 102 and the gripping member 104 are separated apart. The spring clip 100 may receive the busbar 302 and the busbar 304 by inserting the busbar 302 and the busbar 304 between the gripping member 102 and the gripping member 104 while the gripping member 102 and the gripping member 104 are separated apart.

In a step 430, the gripping members may join the busbars. For example, the gripping member 102 and the gripping member 104 may join the busbar 302 and the busbar 304. The gripping member 102 and the gripping member 104 may join the busbar 302 and the busbar 304 by returning the spring clip 100 to the neutral position. The spring clip 100 may be resilient and may recover to an original shape, thereby exerting an inwards force on the busbar 302 and the busbar 304. The inward force on the busbar 302 and the busbar 304 may clip together the busbar 302 and the busbar 304. Thus, the busbar 302 and the busbar 304 may be prevented from translating with respect to each other.

In a step 440, the gripping members may be separated apart thereby releasing the busbars. For example, the gripping member 102 and the gripping member 104 may be separated apart thereby releasing the busbar 302 and the busbar 304. The spring clip 100 may be released when external force is applied separating apart the gripping member 102 and the gripping member 104.

The spring clip 100 may be advantageous to provide ease-of-assembly when joining and releasing the busbar 302 and the busbar 304. The spring clip 100 may streamline the installation of the electrical connector 300 by reducing the number of components.

The spring clip 100 may be adapted for repeated physical engagement or disengagement, with the use of the tool, for establishing or breaking the electrical connector 300. The spring clip 100 may maintain pressure between the busbar 302 and the busbar 304 with repeated assembly and disassembly of the spring clip 100. For example, the spring clip 100 may maintain pressure between the busbar 302 and the busbar 304 with repeated assembly and disassembly of the spring clip 100 for as long as the spring clip 100 is not plastically deformed.

Although the gripping member 102 and/or the gripping member 104 are described as including the straight portion 112, this is not intended as a limitation of the present disclosure. It is contemplated that the corrugated portion 114 may replace the length of the straight portion 112 such that the gripping member 102 and/or the gripping member 104 may not include the straight portion 112.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

100 Spring clip
102 Gripping member
104 Gripping member
106 Trapezoidal member
108 Raised member
110 Raised member
112 Straight Portions
114 Corrugated Portions
116 Rib portions
118 Grooves
120 Hole
122 Hole
300 Electrical connector
302 Busbar
304 Busbar
400 Method
410 Step
420 Step
430 Step
440 Step

What is claimed:

1. A spring clip comprising:
a first gripping member;
a second gripping member, wherein the first gripping member and the second gripping member comprise:
a corrugated portion defining a plurality of grooves; and
one or more rib portions, wherein the one or more rib portions are orthogonal to the plurality of grooves;
a trapezoidal member, wherein the first gripping member and the second gripping member extend from the trapezoidal member, wherein the corrugated portion and the one or more rib portions of the first gripping member join the first gripping member to the trapezoidal member, wherein the corrugated portion and the one or more rib portions of the second gripping member join the second gripping member to the trapezoidal member;
a first raised member, wherein the first raised member extends from the first gripping member, wherein the one or more rib portions of the first gripping member couple between the trapezoidal member and the first raised member; and
a second raised member, wherein the second raised member extends from the second gripping member, wherein the one or more rib portions of the second gripping member couple between the trapezoidal member and the second raised member.

2. The spring clip of claim 1, wherein the trapezoidal member is configured to force the first gripping member and the second gripping member to a neutral position.

3. The spring clip of claim 2, wherein the spring clip is made of steel, aluminum, or magnesium.

4. The spring clip of claim 3, wherein at least the first gripping member, the second gripping member, and the trapezoidal member are formed from a single piece of a resilient material.

5. The spring clip of claim 4, wherein the first raised member is welded to the first gripping member, wherein the second raised member is welded to the second gripping member.

6. The spring clip of claim 4, wherein the first gripping member, the second gripping member, the trapezoidal member, the first raised member, and the second raised member are formed from the single piece of the resilient material.

7. The spring clip of claim 1, wherein the first gripping member is offset from the second gripping member, wherein the spring clip defines a channel between the first gripping member and the second gripping member.

8. The spring clip of claim 1, wherein the first gripping member comprises a first pair of the one or more rib portions, wherein the second gripping member comprises a second pair of the one or more rib portions.

9. The spring clip of claim 8, wherein the first pair of the one or more rib portions are disposed above and aligned with the second pair of the one or more rib portions.

10. The spring clip of claim 8, wherein the first pair of the one or more rib portions abut the first raised member, wherein the second pair of the one or more rib portions abut the second raised member.

11. The spring clip of claim 1, wherein the first raised member and the second raised member define a first hole and a second hole, respectively, wherein the first hole and the second hole are parallel to the one or more rib portions.

12. The spring clip of claim 11, wherein the first hole and the second hole are configured to receive a tool for separating apart the first gripping member and the second gripping member.

13. The spring clip of claim 1, wherein the first gripping member and the second gripping member comprise a straight portion, wherein the corrugated portion is disposed between the straight portion and the trapezoidal member.

14. The spring clip of claim 13, wherein the first raised member extends from the straight portion of the first gripping member and a section of the corrugated portion of the first gripping member, wherein the second raised member extends from the straight portion of the second gripping member and a section of the corrugated portion of the second gripping member.

15. The spring clip of claim 1, wherein the plurality of grooves are rounded grooves.

16. The spring clip of claim 1, wherein the one or more rib portions extend through the plurality of grooves.

17. The spring clip of claim 1, wherein the spring clip is symmetric about a longitudinal axis.

18. An electrical connector comprising:
a spring clip comprising:
a first gripping member;
a second gripping member, wherein the first gripping member and the second gripping member comprise:
a corrugated portion defining a plurality of grooves; and
one or more rib portions, wherein the one or more rib portions are orthogonal to the plurality of grooves;
a trapezoidal member, wherein the first gripping member and the second gripping member extend from the trapezoidal member, wherein the corrugated portion and the one or more rib portions of the first gripping member join the first gripping member to the trapezoidal member, wherein the corrugated portion and the one or more rib portions of the second gripping member join the second gripping member to the trapezoidal member;
a first raised member, wherein the first raised member extends from the first gripping member, wherein the one or more rib portions of the first gripping member couple between the trapezoidal member and the first raised member; and
a second raised member, wherein the second raised member extends from the second gripping member, wherein the one or more rib portions of the second gripping member couple between the trapezoidal member and the second raised member;
a first busbar; and
a second busbar, wherein the first busbar and the second busbar are disposed between the first gripping member and the second gripping member, wherein the first busbar abuts the first gripping member, wherein the second busbar abuts the second gripping member, wherein the first gripping member and the second gripping member join the first busbar and the second busbar.

19. The electrical connector of claim 18, wherein the spring clip joins the first busbar and the second busbar without perforating through the first busbar and the second busbar.

20. A method comprising:
separating apart a first gripping member and a second gripping member of a spring clip, the spring clip comprising:
the first gripping member;
the second gripping member, wherein the first gripping member and the second gripping member comprise:
a corrugated portion defining a plurality of grooves; and
one or more rib portions, wherein the one or more rib portions are orthogonal to the plurality of grooves;
a trapezoidal member, wherein the first gripping member and the second gripping member extend from the trapezoidal member, wherein the corrugated portion and the one or more rib portions of the first gripping member join the first gripping member to the trapezoidal member, wherein the corrugated portion and the one or more rib portions of the second gripping member join the second gripping member to the trapezoidal member;
a first raised member, wherein the first raised member extends from the first gripping member, wherein the one or more rib portions of the first gripping member couple between the trapezoidal member and the first raised member; and
a second raised member, wherein the second raised member extends from the second gripping member, wherein the one or more rib portions of the second gripping member couple between the trapezoidal member and the second raised member;
receiving a first busbar and a second busbar between the first gripping member and the second gripping member while the first gripping member and the second gripping member are separated apart; and
joining the first busbar and the second busbar via the first gripping member and the second gripping member.
